(19) United States
(12) Patent Application Publication
(10) Pub. No.: US 2022/0235475 A1
(43) Pub. Date: Jul. 28, 2022

(54) ELECTROLYSIS DEVICE HAVING TWO BORON DOPED DIAMOND LAYERS

(71) Applicant: FRIEDRICH-ALEXANDER-UNIVERSITÄT ERLANGEN-NÜRNBERG, Erlangen (DE)

(72) Inventors: Rudolf BORCHARDT, Erlangen (DE); Timo FROMM, Parsberg (DE); Hanadi GHANEM, Erlangen (DE); Maximilian GÖLTZ, Möhrendorf (DE); Thomas HELMREICH, Nürnberg (DE); Stefan ROSIWAL, Bamberg (DE)

(21) Appl. No.: 17/617,796

(22) PCT Filed: Jun. 8, 2020
(86) PCT No.: PCT/EP2020/065858

§ 371 Date: Dec. 9, 2021

(30) Foreign Application Priority Data
Jun. 12, 2019 (DE) 10 2019 115 956.3

(51) Int. Cl. C25B 11/083; C25B 9/17; C25B 1/26; C25B 1/13; C25B 1/04; C25C 7/02; C25C 1/00; C02F 1/461; C02F 1/467

(52) U.S. Cl. CPC C25B 11/083; C25B 9/17; C25B 1/26; C25B 1/13; C25B 1/04; C02F 2101/20; C25C 1/00; C02F 1/46109; C02F 1/4674; C02F 2001/46147; C25C 7/02

(57) ABSTRACT

The invention relates to a device for electrolysis comprising a substrate (1, 6) on which an anode formed of a first diamond layer (3) and a cathode formed of a second diamond layer (4) are provided, wherein the first (3) and second diamond layers (4) are each made of diamond doped with boron.

The invention relates to an device for electrolysis, in particular for electrolysis of an aqueous electrolyte, as well as to a method for electrolysis and to a use.

WO 2005/113860 discloses a large-area electrode which is made from a plurality of substrates. The substrates are connected to each other at the edges by means of an electrically conductive connection to form a mechanically stable electrode body. The electrode body is provided, at least on its one side, with an electrically conductive diamond layer. Such electrodes are particularly suitable for use as anode in the treatment of waste water.

More recently, there has been a need for devices for the production of ozone, OH radicals, etc. Such devices are used, for example, in household washing machines for disinfection. Such a washing machine is known, for example, from EP 1 975 299 B1. The currently used devices for the production of ozone use air to generate ozone. Undesirably, toxic nitrogen oxides are also produced in the process.

It is the object of the invention to eliminate the disadvantages according to the prior art. In particular, a device for electrolysis with improved durability is to be disclosed. According to a further object of the invention, the device is also to be manufacturable in miniaturized form in the manner of a chip. The device is intended to enable a process for electrolysis to be carried out simply and inexpensively.

This object is achieved by the features of the independent claims. Useful embodiments of the invention result from the features of the dependent claims.

In accordance with the invention, there is proposed a device for electrolysis comprising a substrate on which there are provided an anode formed of a first diamond layer and a cathode formed of a second diamond layer, the first and second diamond layers each being made of diamond doped with boron.

The first and second diamond layers are electrically conductive because of the doping with boron proposed in accordance with the invention. By providing the first and second diamond layers together on a substrate, the fabrication can be simplified. The device can also be miniaturized in the manner of a chip.

Advantageously, the diamond is doped with 100 to 10,000 ppm boron. The proposed doping provides the diamond with sufficient electrical conductivity to perform electrolysis.

According to a further embodiment, the substrate is (i) made of an electrically insulating material or (ii) made of an electrically conductive material which is provided with an electrically insulating layer on its upper surface facing the diamond layers. In either case, the first and second diamond layers are electrically insulated from each other so that they can act as anode and cathode. By an “electrically insulating material” is meant a material whose electrical conductivity is less than 10⁻² S/m. In particular, the electrically insulating material has a lower electrical conductivity in relation to the electrolyte in contact therewith. An electrically conductive material, on the other hand, has a substantially higher electrical conductivity of generally more than 10 S/m, preferably more than 10² S/m, in particular more than 10⁶ S/m.

The electrically insulating material or layer is suitably formed from at least one of the following materials: Metal oxide, Si, SiC, diamond, SiO₂, fireclay, ceramic, in particular porcelain, or glass. For example, Al₂O₃ or MgO may be used as the metal oxide. Furthermore, it is conceivable to provide SiC or undoped Si as the electrically insulating substrate, and a diamond layer which is not doped with boron as the electrically insulating layer. It is also conceivable to bond a boron-doped CVD diamond film to a substrate. In this case, the bonding can be done, for example, with a polymer adhesive layer, diffusion bonding, a solder or the like. It is also possible to provide a CVD diamond film with a metal layer, which can then be joined to a metallic substrate by ultrasonic welding. CVD diamond foils are known from EP 2 403 974 B1.

According to a further advantageous embodiment, an electrically conductive interlayer may be provided between the first and/or second diamond layer and the electrically insulating substrate or layer, an electrically conductive intermediate layer may be provided which is formed of, for example, Ti, Nb or Ta. The provision of the proposed electrically conductive intermediate layer enables a better distribution of the electric current. In particular, this also enables the fabrication of large area devices for electrolysis. Apart from this, the aforementioned metals form metal carbides in the CVD process. Metal carbides in turn contribute to excellent adhesion of the diamond layer produced by the CVD process to the electrically conductive intermediate layer.

The first and/or the second diamond layer and/or the electrically insulating layer and/or the electrically conductive intermediate layer are expediently produced by means of a CVD process. In particular, the electrically conductive intermediate layer can also be produced by means of a PVD process.

It has been found convenient that a thickness of the first and second diamond layers is 1 to 100 μm. Furthermore, it is advantageous that a surface of the first and second diamond layers facing the substrate is in each case formed to more than 50% from facets which form the (111) or (001) planes of diamond crystals, preferably of diamond single crystals grown together. Diamond coatings having the aforementioned features are particularly durable, in particular particularly resistant to oxidation.

Further, it has been found convenient that the diamond single crystals extend predominantly in a [111] or [110] direction from the substrate or an intermediate layer provided between the substrate and the respective diamond layer to the surface of the diamond layer.

In order to manufacture the device according to the invention, the boron-doped diamond layer is expediently first deposited as a uniform layer by means of a CVD process on the substrate or on an electrically insulating layer or intermediate layer provided on the substrate. Subsequently, the electrically conductive diamond layer is preferably separated into the first and second diamond layers by means of a laser. The first and second diamond layers are thus advantageously separated from each other by an electrically insulating path. Advantageously, the path has a width of 2 to 500 μm. Advantageously, the path is meander-shaped. Because of the proposed small distance between the electrodes facing each other, it is possible to operate the device according to the invention with low working voltages, in particular less than 10 V. In this case, the electric field lines extend only between the anode and the cathode. In particular, they are almost not perpendicular to the surface of the diamond layer, so that decomposition of the intermediate layer holding the diamond layer by anodic oxidation is not possible. The proposed device is particularly suitable for the electrolysis of water, in particular for the production of ozone from water.

According to a further embodiment, a metal layer is provided in sections on the first and/or second diamond layer. Preferably, the metal layer is provided in a section outside the path. The metal layer serves to evenly distribute the current supplied to the diamond layer. It is suitably formed of a self-passivating metal or a noble metal. The metal and/or noble metal may of course also be suitable alloys.

The metal may contain as its main component one of the following elements: Ti, Ta, Nb, Cr, Al, W, Au, Ag.

Between the metal layer and the surface of the first and/or second diamond layer, a further intermediate layer formed of a metal carbide, preferably TiC or WC, is expediently provided. The further intermediate layer serves to improve the adhesion of the metal layer to the diamond layer.

A cover layer of an electrically insulating material, preferably diamond, may be provided on the first and/or second diamond layer, at least in sections. Such a top layer counteracts the unintentional formation of short circuits. The top layer can be easily produced, in particular in the CVD process, in that after the deposition of the first and/or second diamond layer, the boron doping is omitted, i.e. an undoped diamond layer is applied to the first and/or second diamond layer as a top layer.

According to a further embodiment, the top layer or a further top layer made of an electrically insulating material is provided on the metal layer. The further covering layer may be a passivation layer and/or a layer formed of a polymer. The aforementioned layers may have a thickness in the range of 0.001 μm to 10,000 μm. In operation, they serve to reduce hydrogen-induced embrittlement in the region of the cathode and/or oxidation in the region of the anode.

Provided that the first and second diamond layers are overlaid with an electrically insulating top layer and/or further electrically insulating top layer and/or are underlaid with an electrically conductive intermediate layer, the path also passes through the top layer, the further top layer and/or the electrically conductive intermediate layer.

According to a further specification of the invention, a process for electrolysis, in particular for the production of OH radicals, oxidized chlorine compounds, oxidants, ozone, hydrogen oxygen and/or for the cathodic precipitation of metals or metal compounds, is proposed comprising the following steps:

contacting the first and second diamond layers of the device of the invention with an aqueous electrolyte, and

applying a voltage of 3 to 60 volts between the first and second diamond layers, whereby an electric field is formed whose field lines run transversely to a longitudinal direction of the path.

Using the device according to the invention, the proposed process is suitable for the efficient production of, in particular, ozone, OH radicals and the like. A current of 1 to 10,000 mA/cm² can be applied during electrolysis.

With the device according to the invention, it is possible to generate, for example, OH radicals at the anode and oxidizing substances resulting therefrom, such as ozone, peroxides. Chlorine as well as chlorine oxides can be formed from electrolytes containing chlorine ions, for example. At the cathode or in the electrolyte adjacent to the cathode, for example, calcium, many heavy metals, such as iron, uranium, cobalt, nickel, noble metals, such as for example copper, as well as sulfur and arsenic can be deposited either in pure form or in the form of compounds, for example hydroxide, carbonate, sulfate or phosphate compounds. The device according to the invention is not limited to electrolysis in contact with an aqueous electrolyte. It is also conceivable to use the device according to the invention with a non-aqueous electrolyte for the production of desired substances.

The device according to the invention can be used in particular for decalcification or for removing heavy metals from water. By reversing the polarity, it is possible to detach deposited substances from the diamond surfaces. Detached solid substances can be separated from the liquid phase, for example by filtration.

In the following, embodiments of the invention are explained in more detail with reference to the drawing. It shows:

FIG. 1 a schematic sectional view through the layer sequence of a first device,

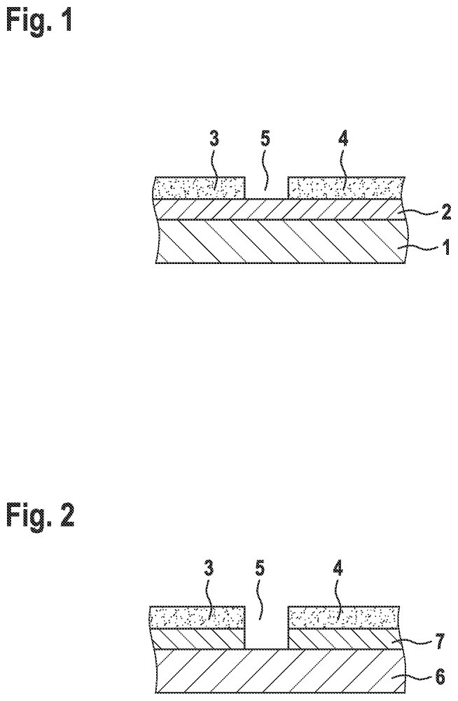

FIG. 2 a schematic cross-sectional view through the layer sequence of a second device,

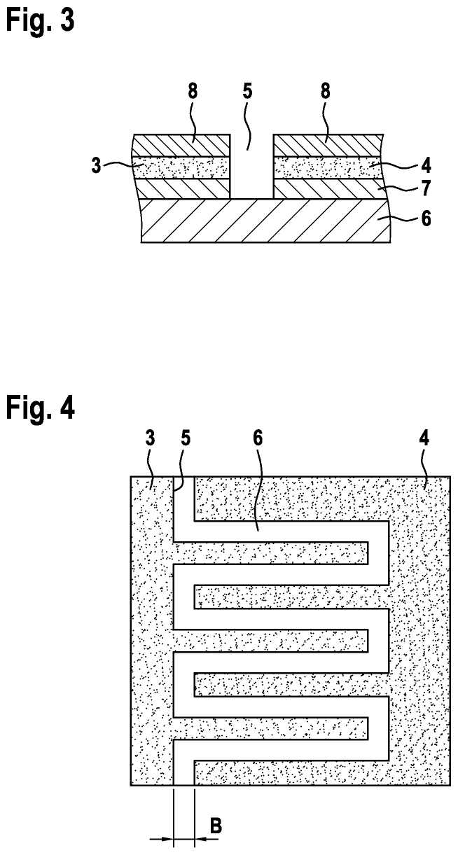

FIG. 3 a schematic cross-sectional view through a layer sequence of a third device,

FIG. 4 a schematic top view of a device for electrolysis,

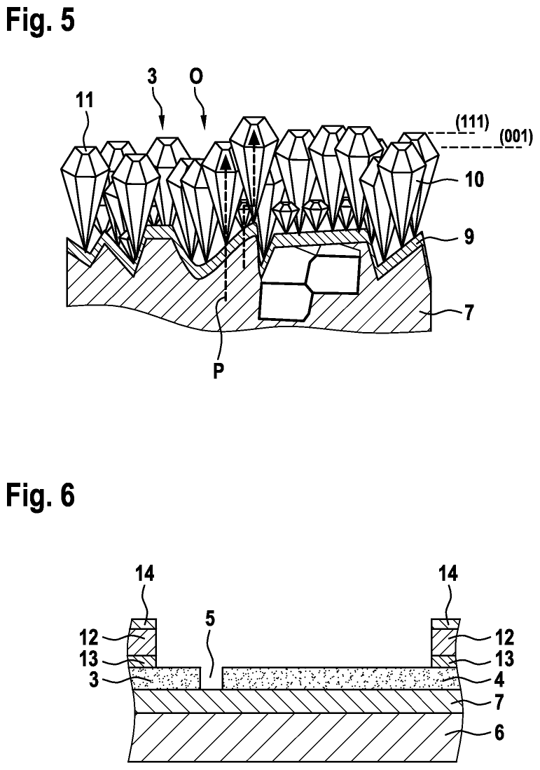

FIG. 5 a schematic sectional view through a first diamond layer deposited on an intermediate layer,

FIG. 6 a schematic cross-sectional view through a layer sequence of a fourth device,

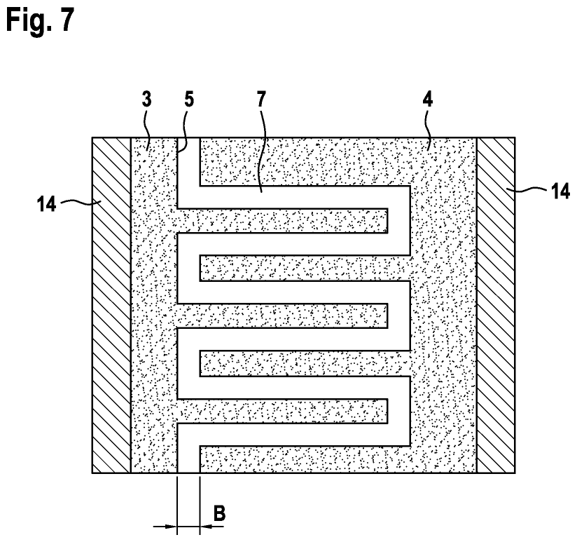

FIG. 7 a schematic top view of the device according to FIG. 6.

In the first device shown in FIG. 1, an electrically insulating layer 2 is provided on an electrically conductive substrate 1, which may be made of Ti, for example. The electrically insulating layer 2 may be made of non-doped diamond, for example. A resistance of the electrically insulating layer 2 is greater than a resistance of water, in particular when the device is used with an aqueous electrolyte.

The first diamond layer 3 and the second diamond layer 4 are provided on the electrically insulating layer 2. The first diamond layer 3 and the second diamond layer 4 are electrically separated from each other by a path 5. The path 5 can optionally also extend through the electrically insulating layer 2 (not shown here).

In the second device shown in FIG. 2, an electrically conductive intermediate layer 7 is provided on an electrically insulating substrate 6, on which the first diamond layer 3 and the second diamond layer 4 are provided. The path 5 passes through both the first 3 and second diamond layers 4, and the electrically conductive intermediate layer 7. The electrically insulating substrate 6 may be made of, for example, porcelain, SiC, Al₂O₃ or the like. The electrically conductive intermediate layer 7 may be made of, for example, Ti, Nb or Ta. The electrically conductive intermediate layer 7 may also be omitted. In this case, therefore, the first 3 and second diamond layers 4 are provided directly on the electrically insulating substrate 6, and an intermediate carbide layer having a thickness in the range of 1 nm to 10,000 nm may be provided between the diamond layers 3, 4 and the substrate 6.

In the third device shown in FIG. 3, in contrast to the second device shown in FIG. 2, a cover layer 8 is provided on each of the first 3 and second diamond layers 4, which cover layer 8 is formed from an electrically insulating material. This may be an electrically insulating diamond.

FIG. 4 shows a top view of a device according to the invention, such as corresponding approximately to the first or second device according to FIG. 1 or 2. The first diamond layer 3 and the second diamond layer 4 are electrically separated from each other by the path 5. The path 5 may have a width B in the range of 2 to 500 μm. The path 5 is suitably formed after depositing a boron-doped conductive diamond layer on an electrically insulating substrate or layer by laser or ion etching. It expediently has a meandering course.

FIG. 5 schematically shows a section of the device shown in FIG. 2. A TiC layer 9 is formed on an electrically conductive intermediate layer 7 made of Ti, for example, which serves as a growth layer for the diamond crystals. From the TiC layer 9, diamond single crystals 10 extend to more than 50%. The facets of the diamond single crystals 10 denoted by the reference sign 11 are formed from either the (111) plane or the (001) plane. The reference sign P denotes the growth direction of the diamond single crystals 10.

A surface O of the first diamond layer 3 is formed by the totality of the facets 11. The second diamond layer 4 is formed analogously to the first diamond layer 3.

A current flow occurs between the first diamond layer 3 and the second diamond layer 4 substantially perpendicular to the growth direction P or across the path 5.

FIG. 6 shows a schematic cross-sectional view through the layer sequence of a fourth device. The fourth device is similar to the second device shown in FIG. 2. A metal layer 12 is provided here in sections on a surface of the first diamond layer 3 and the second diamond layer 4, respectively. The metal layer 12 may optionally be bonded to the surface of the diamond layers 3, 4—as shown in FIG. 6—by means of an interposed metal carbide layer 13. A polymer layer 14 may be provided on the surface of the metal layer 12 to protect it. Instead of the polymer layer 14, a passivation layer may also be provided. The polymer layer and/or the passivation layer are optional.

FIG. 7 shows a schematic top view on the fourth device according to FIG. 6. The metal layer 12 is provided only in sections on the first 3 and the second diamond layer 4, which are located outside the structures forming the meandering path 5.

### LIST OF REFERENCE SIGNS

1 electrically conductive substrate

2 electrically insulating layer

3 first diamond layer

4 second diamond layer

5 path

6 electrically insulating substrate

7 electrically conductive interlayer

8 cover layer

9 TiC layer

10 diamond single crystal

11 facet

12 metal layer

13 metal carbide layer

14 polymer layer

B broad

O surface

P growth direction

1.-20. (canceled)

21. An electrolysis device comprising a substrate (1, 6) on which an anode formed of a first diamond layer (3) and a cathode formed of a second diamond layer (4) are provided, said first (3) and second diamond layers (4) each being made of boron-doped diamond,
Wherein
the first (3) and the second diamond layer (4) are separated from each other by an electrically insulating path (5) and are arranged in such a way that, when a voltage is applied between the first (3) and the second diamond layer (4), an electric field is formed, the field lines of which run at least partially transversely to a longitudinal extension direction of the path (5).

22. The device of claim 21, wherein the diamond is doped with 100 to 10,000 ppm boron.

23. The device according to claim 21, wherein the substrate (1, 6) is (i) made of an electrically insulating material or (ii) made of an electrically conductive material which is provided with an electrically insulating layer (2) on its upper side facing the diamond layers.

24. The device according to claim 23, wherein the electrically insulating material or layer (2) is formed of at least one of the following materials: metal oxide, Si, SiC, diamond, SiO₂, fireclay, ceramic, preferably porcelain, or glass.

25. The device according to claim 23, wherein between the first (3) and/or second diamond layer (4) and the electrically insulating substrate (6) or the electrically insulating layer (2) an electrically conductive intermediate layer (7) is provided, which is preferably formed of Ti, Nb or Ta.

26. The device according to claim 21, wherein the first (3) and/or the second diamond layer (4) and/or the electrically insulating layer (2) and/or the electrically conductive intermediate layer (7) are produced by means of a CVD process.

27. The device according to claim 21, wherein a thickness of the first (3) and second diamond layers (4) is 5 to 100 μm.

28. The device according to claim 21, wherein a surface (O) of the first (3) and second diamond layers (4) facing the substrate (1, 6) is formed by more than 50% each of facets (11) forming the (111) or (001) planes of diamond crystals, preferably of diamond single crystals (10) grown together.

29. The device according to claim 28, wherein the diamond single crystals (10) extend predominantly in a [111] or [110] direction from the substrate (1, 6) or an intermediate layer (7) provided between the substrate (1, 6) and the respective diamond layer (3, 4) to the surface (O) of the respective diamond layer (3, 4).

30. The device according to claim 21, wherein the path (5) has a width of 2 to 500 μm.

31. The device according to claim 21, wherein the path (5) is meandering.

32. The device according to claim 21, wherein a metal layer (12) is provided on the first (3) and/or second diamond layer (4) in a portion outside the path.

33. The device according to claim 32, wherein the metal layer (12) is formed of a self-passivating metal or of a noble metal.

34. The device of claim 33, wherein the metal includes, as a major constituent, any one of the following elements: Ti, Ta, Nb, Cr, Al, W, Au, Ag.

35. The device according to claim 32, wherein between the metal layer (12) and the surface (O) of the first (3) and/or second diamond layer (4), a further intermediate layer (13) formed of a metal carbide, preferably TiC or WC, is provided.

36. The device according to claim 21, wherein a cover layer (8) of an electrically insulating material, preferably of diamond, is provided on the first (3) and/or second diamond layer (4) at least in sections.

37. The device according to claim 32, wherein the cover layer (8) or a further cover layer (14) of an electrically insulating material is provided on the metal layer (12).

38. Method for electrolysis, in particular for the production of OH radicals, oxidized chlorine compounds, oxidants, ozone, hydrogen, oxygen and/or for the cathodic precipitation of metals or metal compounds, comprising the following steps:
contacting the first (3) and second diamond layers (4) of the device according to any one of the preceding claims with an aqueous electrolyte, and
applying a voltage of 3 to 60 volts between the first (3) and second diamond layer (4), whereby an electric field is formed, the field lines of which run at least partially transversely to a longitudinal direction of the path (5).

39. Use of the apparatus according to claim 21 for producing OH radicals, oxidized chlorine compounds, ozone, hydrogen and/or oxygen.
